(19) United States
(12) Patent Application Publication
(10) Pub. No.: US 2007/0234842 A1
(43) Pub. Date: Oct. 11, 2007

(54) ELECTRONIC THROTTLE CONTROL WITH HYSTERESIS AND KICKDOWN

(75) Inventor: RYAN W. ELLIOTT, Chatham (CA)

Correspondence Address: GIFFORD, KRASS, SPRINKLE,ANDERSON & CITKOWSKI, P.C, PO BOX 7021, TROY, MI, 48007-7021, US

(73) Assignee: KSR International Co., Ridgetown (CA)

(21) Appl. No.: 11/697,333

(22) Filed: Apr. 6, 2007

Related U.S. Application Data
(60) Provisional application No. 60/790,269, filed on Apr. 7, 2006.

(51) Int. Cl. G05G 1/14

(52) U.S. Cl. 74/513

(57) ABSTRACT

An electronically controlled pedal with hysteresis and kickdown includes a housing having a friction wall with a first frictional surface having a first radius of curvature, a second frictional surface having a second radius of curvature, and a step transitioning between the two. A hysteresis and kickdown generating means is pivotally attached to the upper pedal arm. A spring biases the generating means against the housing. Application of a first pedal load to the pedal arm generates a first hysteresis force between the hysteresis and kickdown generating means and the first frictional surface. Application of a second pedal load to the pedal arm generates a frictional kickdown force between the generating means and the step, and application of a third pedal load generates a second hysteresis force between the generating means and the second frictional surface. The first hysteresis force, kickdown force and second hysteresis force are transmitted back to the operator.

### CROSS-REFERENCE TO RELATED APPLICATIONS

This application claims priority of U.S. Provisional Patent Application Ser. No. 60/790,269 filed Apr. 7, 2006, which is incorporated herein by reference.

### BACKGROUND OF THE INVENTION

1. Field of the Invention

The present invention relates generally to electronic controls for vehicles, and more particularly, to an electronically controlled pedal with hysteresis and kickdown.

2. Description of the Related Art

Vehicles, and in particular automotive vehicles, utilize a foot-operated device, such as a brake pedal or a throttle control pedal, also referred to as an accelerator pedal, to control the movement of the vehicle. Conventional brake systems include a brake pedal for transmitting a braking force from the vehicle operator to the wheels of the vehicle. Similarly, conventional throttle control systems include a throttle pedal to transmit a signal from the vehicle operator to a controller to control acceleration and movement of the vehicle. Recent innovations in electronics technology have led to increased use of electronic controls for vehicle systems, such as the throttle system or the brake system.

In an electronically controlled throttle control system, the pedal arm is attached to a position sensor, which senses the relative position of the pedal arm and transmits a signal to a controller to operate the throttle. The electronically controlled brake system operates in a similar manner. However, since the pedal arm is not attached to a mechanical device, such as a rod or cable, there is no resistance to depression of the pedal, and the pedal returns to a nominal position quicker than with a mechanical system. This resistance is referred to as hysteresis. Hysteresis is advantageous because it provides the driver with a better “feel” of the pedal. Without a predetermined amount of hysteresis in the pedal, the driver may experience increased foot fatigue from the rapid adjustment of the pedal, especially when driving over a long period of time. In the past, a mechanical device was utilized to simulate the resistance to depression produced by a brake rod or a throttle cable in a conventional pedal system, and return the pedal to its resting position. An example of a mechanical device is a friction pad connected to an extension of the pedal arm to develop hysteresis during depression of the pedal. However, previously known hysteresis devices are complicated and utilize many parts. An example of a hysteresis device for use with an electronic throttle control is disclosed in commonly assigned U.S. patent application Ser. No. 10/621,904, which is incorporated by reference.

Also, a vehicle with a mechanical pedal system included a mechanical device, such as a cable or rod, that transmitted the actuation of the pedal and throttle to the automatic transmission, in order to effect a kickdown or downshift of the transmission to a lower gear during certain types of acceleration. The downshift or kickdown to a lower gear generally improves the acceleration of the vehicle. The driver can feel the kickdown, since increased force is required to actuate the pedal. For a vehicle with an electronically controlled throttle control system and an electronic transmission, there is no need for mechanical device, such as a rod or cable, to initiate kickdown, since the acceleration can be sensed through various sensors and communicated to the transmission. While a mechanical linkage, such as a cable or rod or the like, may be used on a vehicle with an electronic transmission to replicate kickdown, it is an added expense.

Vehicle drivers are used to the “feel” associated with kickdown during acceleration, as well as hysteresis during pedal actuation. Thus, there is a need in the art for an electronically controlled pedal that replicates both pedal hysteresis and mechanical kickdown.

### SUMMARY OF THE INVENTION

Accordingly, an electronically controlled pedal with a hysteresis and kickdown generating device is provided. The electronically controlled pedal assembly includes a housing having a mounting wall, a pair of opposed sidewalls, and an end wall. The end wall includes a friction wall having a first frictional surface with a first radius of curvature centered on a pedal arm pivot point and a second frictional surface with a second radius of curvature centered on the pedal arm pivot point that is less than the first radius of curvature, and a step transitioning between the first frictional surface and the second frictional surface. A pedal arm is operatively attached to the housing at the pivot point. A hysteresis and kickdown generating means is pivotally attached to the upper pedal arm. A spring is positioned between the housing and the hysteresis and kickdown generating means to bias the hysteresis and kickdown generating means against the housing. Rotation of the pedal arm by application of a first pedal load to the pedal arm compresses the spring to generate a first frictional hysteresis force between the hysteresis and kickdown generating means and the first frictional surface of the friction wall that is translated back through the pedal arm. Further rotation of the pedal arm by application of a second pedal load to the pedal arm generates a frictional kickdown force between the hysteresis and kickdown generating means and the step portion. Continued rotation of the pedal arm by application of a third pedal load to the pedal arm generates a second hysteresis force between the hysteresis and kickdown generating means and the second frictional surface of the friction wall, and the first hysteresis force, kickdown force and second hysteresis force are translated back through the pedal arm.

One advantage of the present invention is that an electronically controlled pedal assembly is provided that includes an integrated hysteresis and kickdown device to simulate both the resistance to depression of the pedal and downshift of the transmission during acceleration. Another advantage of the present invention is that the integrated hysteresis and kickdown generating device for the electronically controlled pedal is simpler in design than previous attempts, to enhance packageability within the interior environment of the vehicle. Still another advantage of the present invention is that a pedal assembly with the integrated hysteresis and kickdown generating device is cost-effective to manufacture.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a perspective view of an electronically controlled pedal assembly, according to the present invention;

FIG. 2 is a side view of the pedal assembly of FIG. 1 with an embodiment of a hysteresis and kickdown generating device, according to the present invention;

FIG. 3 is a side view of the pedal assembly of FIG. 1 with another embodiment of a hysteresis and kickdown generating device, according to the present invention;

FIG. 4 is a side view of the pedal assembly of FIG. 1 with still another embodiment of a hysteresis and kickdown generating device, according to the present invention;

FIG. 5 is a side view of the pedal assembly of FIG. 1 with yet still another embodiment of a hysteresis and kickdown generating device, according to the present invention;

FIG. 6 is an enlarged view of the pedal assembly of FIG. 4 at an initial position, according to the present invention;

FIG. 7 is an enlarged view of the pedal assembly of FIG. 4 at a kickdown position, according to the present invention;

FIG. 8 is a partial view of the inner surface of the friction wall, according to the present invention;

FIG. 9 is a graph illustrating the load on the pedal versus pedal travel, according to the present invention.

### DETAILED DESCRIPTION OF THE INVENTION

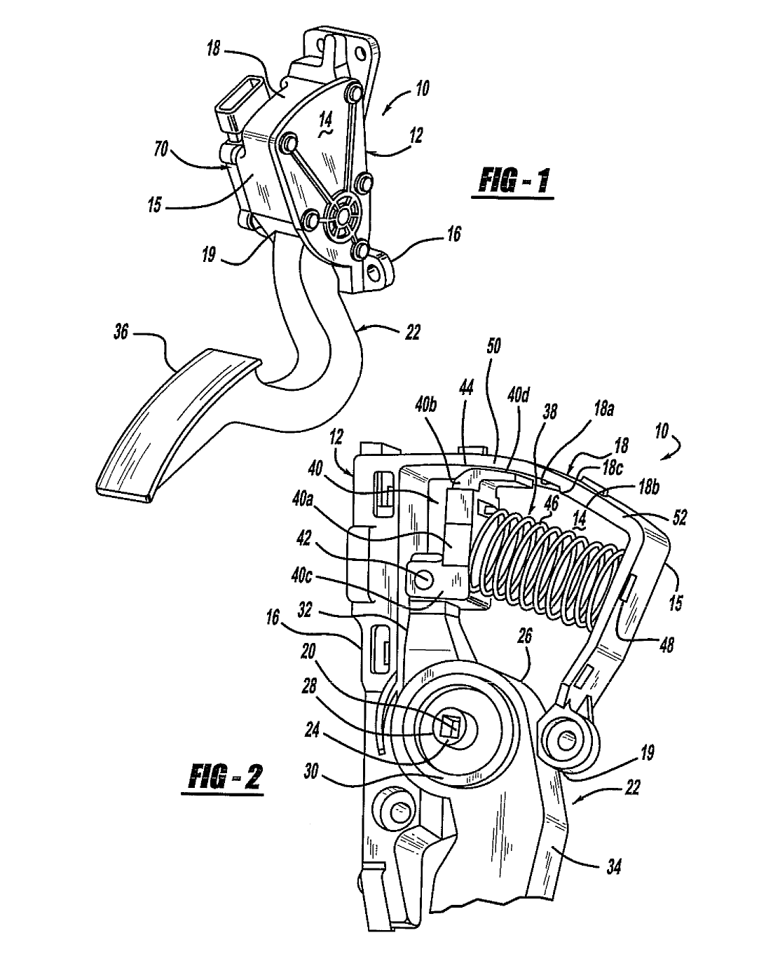

Referring to FIGS. 1 and 2, an electronically controlled pedal assembly is illustrated. It should be appreciated that in this example the electronically controlled pedal is a throttle pedal for a vehicle, such as an automotive vehicle. In addition, the vehicle includes an electronically controlled automatic transmission.

The electronic throttle control pedal assembly 10 of this example transmits a signal from the driver to a throttle controller (not shown) regarding movement of the vehicle. The pedal assembly 10 includes a housing 12 having a mounting wall with tabs 16 for mounting the pedal assembly 10 to a vehicle (not shown). The housing includes a pair of spaced apart side walls 14 and a curved end wall 15 between the side walls 14 that define a cavity. An opening is formed in the lower portion of the housing as shown at 19, between the end wall 15 and the mounting wall 16.

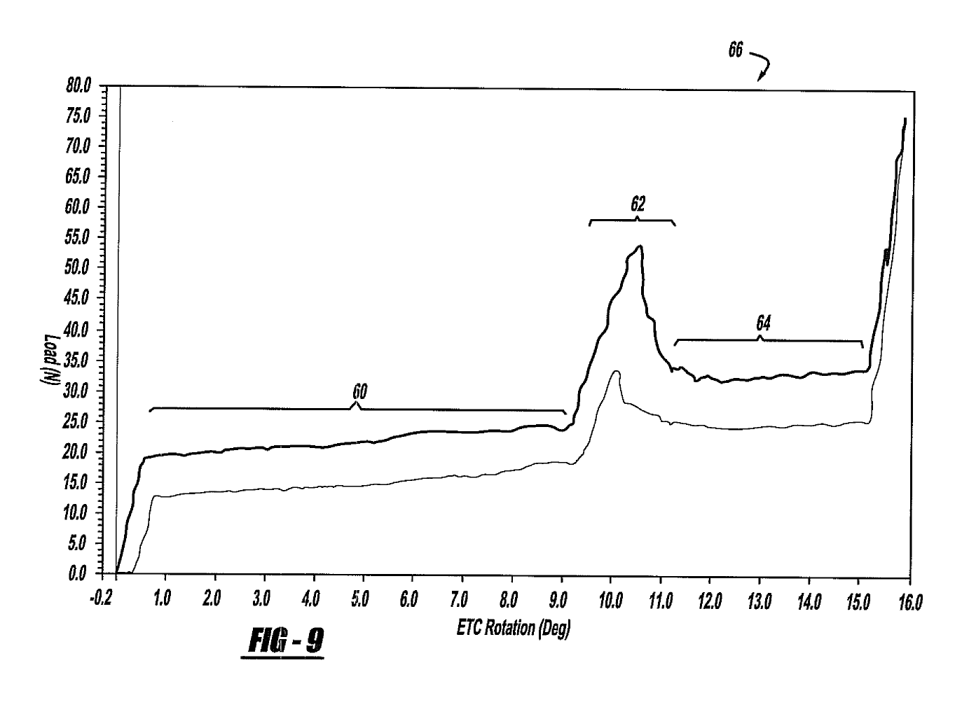

The end wall 15 includes a friction wall portion 18 that has an overall arcuate shape and a radius of curvature centered at a pedal arm pivot point 20. As shown in FIG. 8, the friction wall 18 includes a first frictional surface 18a and a second frictional surface 18b. The first frictional surface 18a is adjacent the mounting wall 16, and is centered on a radius of curvature defined by the pedal arm pivot point 20 as shown at 54a. The first frictional wall surface 18a has a first predetermined wall thickness, as shown at 50. The second frictional surface 18b is outboard of the first frictional surface 18a. The second frictional surface 18b has a second predetermined wall thickness as shown at 52. The second predetermined friction wall thickness 52 is greater than the first predetermined friction wall thickness 50. As a result, the second frictional surface 18b has a second radius of curvature 54b that is less than the first radius of curvature 54a for the first frictional surface 18a. For example, the first frictional surface wall thickness 50 is 0.7 mm less than the second frictional surface wall thickness 52. The difference between the first radius 54a and second radius 54b can be adjusted to modify the kickdown force and second hysteresis force.

The first frictional surface 18a and second frictional surface 18b are separated by a step 18c or ramped portion of the friction wall 18. The step 18c provides a transition between the first frictional surface 18a of the friction wall 18 and the second frictional surface 18b of the friction wall 18. The step 18c can assume various shapes, depending on the desired kickdown force. For example, the step 18c can be an angled wall 18c that projects downwardly away from the first frictional surface at a predetermined angle. For example, 45 degrees from the first frictional surface 18a. In another example, the step 18c can have another wall shape, such as a backwards “J” shape. The corner between the first frictional surface 18a and step 18c or step 18c and second frictional surface 18b may have a radius. It should be appreciated that the shape and dimensional characteristics of the step 18c influence the kickdown “feel”, and are varied to achieve the desired kickdown “feel”. Further, the location of the step 18c, and length of the first frictional surface 18a, or second frictional surface 18b are generally determinable based on predetermined transmission shift points. Generally, the step 18c is located nearer the end of the travel of the pedal than the beginning.

It should be appreciated various techniques may be utilized to influence the frictional characteristics of the friction wall 18. For example, any one of the first frictional surface 18a, second frictional surface 18b or transitional step 18c may be abraded. In another example, a frictional member 56, such as a friction pad or the like, may be disposed on any of the first frictional surface 18a, second frictional surface 18b or transitional step 18c, in order to provide additional resistance. In a further example, a material used for a friction shoe, to be described, is selected having a predetermined coefficient of friction, to achieve the desired hysteresis and kickdown feel.

The pedal assembly 10 includes a pedal arm 22 rotatably supported by a mounting means, as shown at 24. The pedal arm 22 includes a mounting portion, which in this example is disc shaped, and that is supported by the mounting means 24. The pedal arm 22 also includes an upper pedal arm member 32 extending radially from an upper edge pedal arm of the mounting portion 26, generally towards the friction wall 18. The pedal arm 22 also includes a lower pedal arm member 34 extending radially from a lower edge of the mounting portion 26. A pedal pad 36 that is actuated by a driver's foot (not shown) is attached to a distal end of the lower pedal arm member 34 using an attaching means, such as a pivot pin or the like. The lower pedal arm 22 extends through the lower opening 19 in the housing 12. The upper pedal arm 32 and lower pedal arm 34 may be integrally formed as one member, or as two members that operate together.

The mounting means 24 rotatably supports the pedal arm 22, so that the pedal arm 22 rotates about the pedal arm pivot point 20. Various examples of mounting means 24 are contemplated. One example of a mounting means is a pivot pin. Another example of a mounting means is a hub on each side of the pedal arm. Still another example of a mounting means is a hub and post arrangement.

In the example of a hub and post, the mounting means 24 may be a pivot pin mounted to the housing and supporting the pedal arm. Alternatively, the mounting means may include a post extending radially from one side of the mounting portion of the pedal arm 26 at a pedal arm pivot point 20. The post includes a longitudinally extending bore 28 extending partially therethrough for receiving a position sensing device 70. The post is supported by the housing. The opposite side of the pedal arm disk portion 26 includes a longitudinally extending bore (not shown) for receiving another post integrally formed in the housing. The mounting means may include a bushing 30.

The electronically controlled pedal assembly 10 further includes an integrated hysteresis and kickdown generating device 38. The upper pedal arm member 32 is operatively in communication with the integrated hysteresis and kickdown generating device 38. In this example, the integrated hysteresis and kickdown device includes a friction lever 40 pivotally mounted to a distal end of the upper pedal arm member 32 at a friction lever pivot point shown at 42. In this example, the friction lever 40 generally has an “S” shape, and is integral and formed as one piece.

The friction lever 40 of this example includes an integrally formed main member 40a, an upper member 40b extending radially from an upper edge of the main member 40a and a lower member 40c extending radially from a lower edge of the main member 40a. The distal end of the friction lever lower member 40c is pivotally connected to the upper pedal arm member 32 at the friction lever pivot point 42. The friction lever upper member 40b has an arcuate shape that is complementary with the shape of the first frictional surface 18a of the friction wall 18. The friction lever upper member 18b may have a frictional feature that influences generating the hysteresis or kickdown feel. For example, the outer surface 40d of the friction lever upper member 40b may be abraded, to frictionally engage the corresponding arcuate surface of the friction wall 18. In another example, the material of the friction lever upper member 40b is selected according to a desired amount of friction to be generated between the friction lever upper member 40b and the friction wall 18. An example of a material is a plastic or a metal.

The friction lever 40 is initially biased against the housing 12, as shown at 44, by a spring member 46. In this example, the spring 46 is a compression spring. It is positioned between the friction lever 40, and in particular the main member 40a of the friction lever 40, and a spring attachment portion of the end wall 15 of the housing 12, as shown at 48. There may be two springs 46 in parallel with each other. In this example, the spring 46 has one end fixedly attached to the spring attachment portion of the housing end wall 48, and a second end fixedly attached to the friction lever 40. The spring 46 extends between the housing 12 and the friction lever 40, in order to generate friction during actuation of the pedal, to provide the hysteresis feel to the vehicle operator.

The electronically controlled pedal assembly 10 further includes a position sensing device 70 operatively supported by the mounting means 24 at the pedal arm pivot point 24. The sensing device 70 is used to sense the rotational movement of the pedal arm 22, which is indicative of the relative pedal position, and transmit a signal to a control means (not shown) to operatively control a throttle controller (not shown) and thus the movement of the vehicle. Preferably the signal is a proportional voltage signal. It should be appreciated that the electronically controlled pedal assembly 10 may include a blade (not shown) operatively connected to the sensing device 70 to generate a signal indicative of the position of the pedal arm 22 during operation.

Various types of position sensing devices are known in the art to sense rotational movement. One example of such a sensing device is a potentiometer. Another example of a sensing device is an induction sensor. The induction sensor utilizes inductance changes in a transducer circuit to produce an output signal representing the change in position of the pedal arm 22. Advantageously, the induction sensor works well in harsh environments or in environments subject to fluctuations in temperature. One example of an induction sensor utilizes a linear or a rotary variable differential transformer means, or a Hall effect detection of magnetic change, to convert a displacement or angular measurement to an electronic or electromagnetic signal. While these types of sensors work well, they require complex electronic circuitry to transduce a signal, and are expensive to manufacture.

Another example of an induction sensor is disclosed in U.S. Pat. No. 6,384,596, the disclosure of which is incorporated herein by reference. An example of a cap assembly for use with an electronically controlled pedal assembly is disclosed in commonly assigned U.S. patent application Ser. No. 10/621,904, which is incorporated herein by reference. The induction sensor 70 operatively senses the angular movement of the pedal arm 22 about the pedal arm pivot point 20, and transmits a proportional signal, such as a voltage signal, to a controller. The controller analyzes the signal, and transmits a signal to the throttle controller instructing the throttle controller to actuate the throttle accordingly.

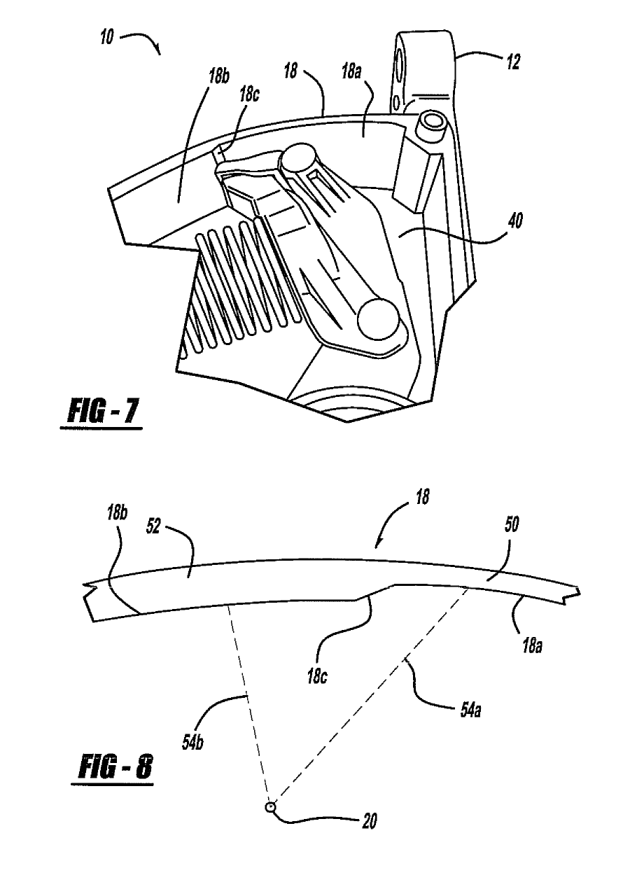

In operation, as the pedal arm 22 is depressed by the operator, the mounting portion 26 and upper pedal arm 32 rotates. As the pedal arm 22 and friction lever 40 rotate, the spring 46 is compressed between the friction lever 44 and the end wall 15 of the housing 12. At the same time, the friction lever upper member 40a travels along the first frictional surface 18a of the friction wall 18, as shown in FIG. 6. The force of the spring 46 works in opposition to the force of the pedal arm to pivot the friction lever 40 slightly. The friction lever arcuate portion 40d is canted slightly with respect to the arcuate first frictional surface 18a of the friction wall 18, like a cam, to generate friction that provides a first hysteresis force. With continued actuation of the pedal, the friction lever upper member 40b reaches the raised step portion 18c of the friction wall 18. The operator must increase the load on the pedal pad and pedal arm, to move the friction lever upper member 40b over the step 18c, as shown in FIG. 7. This increase of load to overcome the step results in the feel of kickdown to the vehicle operator. The angled step increases the force on the friction member in a direction tangent to the direction of rotation. With additional actuation of the pedal arm, the friction lever upper member 40b then travels along the second frictional surface 18b of the friction wall 18. The vehicle operator utilizes a greater load to move the friction lever upper member 40b along the second frictional surface 18b of the friction wall 18 than utilized to move the friction lever upper member 40b along the first frictional surface 18b of the friction wall 18 to generate a second hysteresis force. It should be appreciated that the location of the step 18c can be predetermined, so that the feeling of kickdown occurs at a similar transmission shift point during acceleration as experienced with a mechanical kickdown system.

When the load on the pedal arm 22 is released to permit the pedal arm 22 to return towards a resting portion, the spring force on the rear wall of the friction lever 18 pivots the friction lever upper portion 40b into coaxial alignment with the friction wall arcuate surface 18, thereby reducing the friction between the frictional surface 40d of the upper portion friction member 40b and friction wall 18, and permitting return of the pedal arm 22 to a resting position.

Referring to FIG. 9, a graph of load on the pedal assembly versus pedal rotation due to the hysteresis and kickdown generating device 38 is illustrated at 66. As shown at 60, the load is fairly constant while the friction lever 40 is traveling across the first frictional surface to represent a first hysteresis force. An increased load is required to overcome the step, as shown at 62, representing a kickdown force. A second load, as shown at 64, represents the second hysteresis force generated by moving along the second frictional surface 18b.

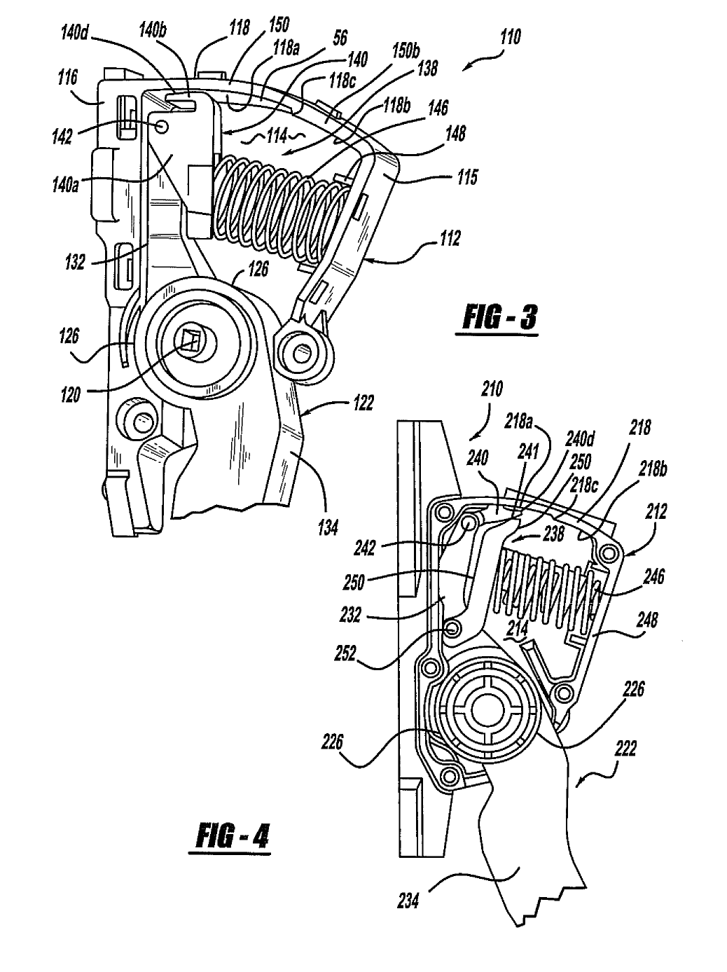

Referring to FIG. 3, another embodiment of an electronic throttle control pedal assembly 110 with a hysteresis and kickdown device 138 is illustrated. It should be appreciated that like components have like reference numbers increased by 100 with respect to the embodiment in FIG. 1. The housing is similar to the previously described housing. The friction wall 118 includes a first frictional wall surface 118a, a second frictional wall surface 118b and a step 118c transitioning between the first frictional wall surface 118a and the second frictional wall surface 118b.

In this example, the pedal arm 122 includes an upper pedal arm 132 extending radially from the pedal arm mounting portion 126 towards the friction wall 118. The pedal arm 122 also includes a lower pedal arm with pedal pad attached thereto. It should be appreciated that the upper pedal arm 132 in this embodiment is longer than the upper pedal arm in the previous embodiment. A friction lever 140 is pivotally mounted to a distal end of the upper pedal arm 132 at a friction lever pivot point as shown at 142. The friction lever 140 has a main member 140a, and an upper member 140b extending forwardly from the friction lever main member 140a. The friction lever upper member 140b is arcuate in shape and has an outer surface 140d complementary with an inner arcuate surface of the friction wall 118. As previously described, the frictional resistance is predeterminable. For example, the upper member arcuate surface 140d may be abraded, to frictionally increase the resistance between the upper member arcuate surface 140d and the friction wall 118, which may also be abraded.

The pedal assembly 110 further includes a spring member 146, such as a compression spring, positioned between the friction lever main portion 140a and a spring attachment portion of the end wall 115, as shown at 148. It should be appreciated that the friction lever is adapted to receive one end of the spring, and the end wall 115 is adapted to receive the second end of the spring. In this example, there are two springs in parallel, that is, an inner spring and an outer spring. The inner and outer spring are used to create a load in the system and the hysteresis feel that is perceived by the operator. Advantageously, if one of the springs fails, the other is still operational.

In this example, as the pedal arm 122 is depressed, the mounting portion 126 of the pedal arm rotates and the spring 146 is compressed between the friction lever 140 and end wall 115 of the housing 112. The force of the spring 146 works in opposition to the force of the pedal arm 112 to pivot the friction lever 140 slightly. The friction lever arcuate portion 140d is canted slightly with respect to the first frictional surface 118a like a cam, to generate friction that is transmitted to the operator as hysteresis as it travels along the first frictional surface 118a. When the friction lever reaches the step 118c, additional force is required to move the friction lever 140 over the step 118c. This additional pressure provides the feeling of kickdown to the operator. Slightly less force is required to continue moving the friction lever 140 along the second frictional surface 118b. When the load on the pedal arm 122 is released to permit the pedal arm 122 to return towards rest, the spring force on the rear wall of the friction lever 140a pivots the friction lever upper member 140b into coaxial alignment with the friction wall 118 thereby reducing the friction between the frictional surface of the upper member 140b and friction wall 118 and permitting return of the pedal arm 122 to a resting position. In this embodiment, the hysteresis is developed at an increased rate since the pedal arm 122 travels through a greater arc with respect to the friction lever 140. As a result, there is greater interference between the frictional surfaces of the friction lever 140 and the friction wall 118. Similarly, the feeling of kickdown can be likewise increased.

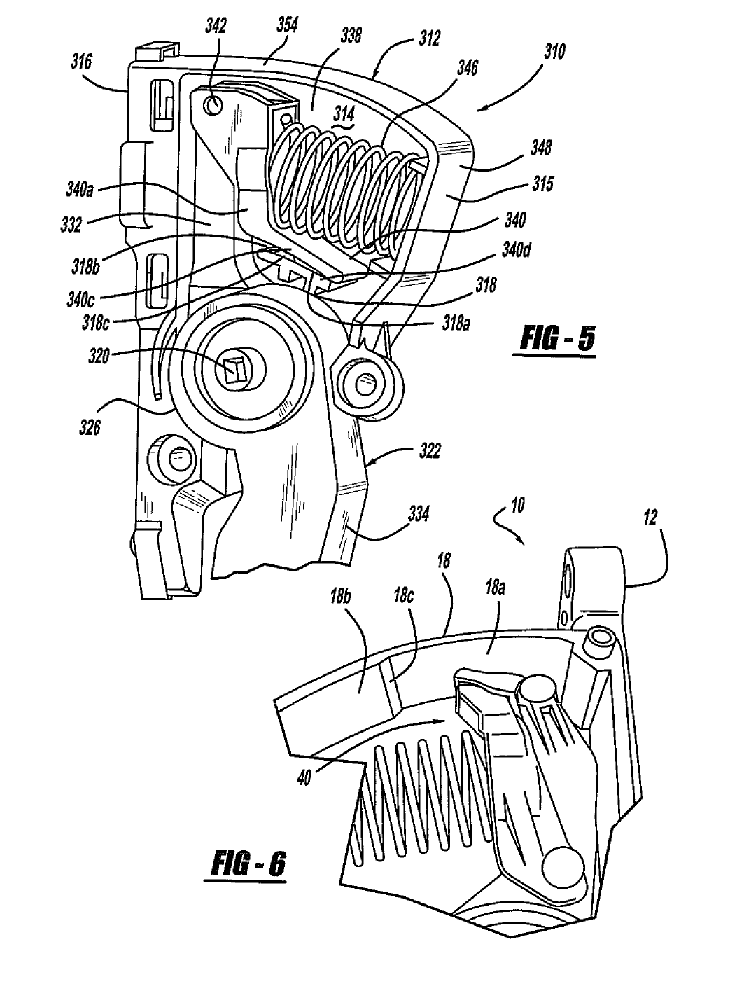

Referring to FIG. 4, still another embodiment of an electronic throttle control pedal assembly 210 with a hysteresis kickdown device 238 is illustrated. It should be appreciated that like components have like reference numbers increased by 200 with respect to the embodiment in FIG. 1. It should also be appreciated that this pedal assembly 210 is similar to the previously described embodiments. The pedal arm 222 includes a mounting portion 226, an upper pedal arm 232 extending radially from an upper edge of the mounting portion 226, and a lower pedal arm 234 extending radially from a lower edge of the mounting portion 226. The upper pedal arm 232, pedal arm mounting portion 226 and lower pedal arm 234 may be integral and formed as one member, as previously described.

The pedal assembly 210 includes a housing having a mounting wall 216, a pair of spaced apart side walls 214, and an end wall 215. A portion of the end wall 215 is a friction wall 218, as shown in FIG. 8. An inner surface of the friction wall 218 may be abraded. As previously described, the first frictional surface 218a of the friction wall 218 may have an arcuate shape and a first radius of curvature centered at a pedal arm pivot point 220. The transitional step 218c portion of the friction wall 218 separates the first and second frictional surface 218a, 218b, respectively. The second frictional surface 218b has a second radius of curvature centered at a pedal arm pivot point 220. The first radius of curvature is greater than the second radius of curvature.

The hysteresis and kickdown generating device 238 includes a friction lever 240 that is pivotally mounted to the upper pedal arm 232 at a friction lever pivot point 242. The friction lever 240 extends from an outer portion of the upper pedal arm 232 and curves rearwardly towards the end wall of the housing 212. The friction lever 240 may include an abraded surface 240d, or another features, as previously described, to increase frictional resistance. The friction lever is biased against the friction wall 218 by a push arm 249 and a spring 246.

The push arm 249 is pivotally mounted to the upper pedal arm 232 at a push lever pivot point 247. In this example the push lever pivot point 247 is located radially inwards from the friction lever pivot point 242. The push lever arm 249 curves upwardly and rearwardly towards the friction wall 218, so as to contact a lower surface of the friction lever 240 at a predetermined contact point, as shown at 241. It should be appreciated that the contact point 241 is selected by the amount of frictional force desired. That is, increasing the distance between the contact point 241 and the friction lever pivot point 242 increases the amount of friction generated by the hysteresis and kickdown generating device 238. The system 210 also includes a spring 246 having one end mounted to the end wall 215 of the housing 212 and the other end to the push arm 249. The spring 246 forces the push arm 249 against the friction lever 240 to generate greater friction, as previously described. The friction lever operates as previously described in order to generate a feeling of hysteresis and kickdown during actuation of the pedal.

Referring to FIG. 5, still another embodiment of an electronic throttle pedal assembly 310 with a hysteresis and kickdown generating device 338 is illustrated. It should be appreciated that like components have like reference numbers increased by 300 with respect to the embodiment in FIG. 1. It should also be appreciated that the pedal assembly 310 is similar to the previously described embodiments. The pedal arm 322 includes a mounting portion 326, an upper pedal arm 332 extending radially from an upper edge of the mounting portion 326, and a lower pedal arm extending radially from a lower edge of the mounting portion 326. The pedal assembly 310 includes a housing 312 having a mounting wall 316, side walls 314 extending from an edge of the mounting wall 316, and an end wall 315, as previously described. In this example, a friction wall 318 extends radially from the side wall 314 of the housing 312, and is positioned below the friction lever 318. The friction wall 318 is spaced radially outwardly from the pedal arm mounting portion 326, but inwardly from the end of the upper pedal arm 332. The friction wall 318 is arcuate in shape and includes a first frictional surface 318a, a second frictional surface 318b, and a step 318c transitioning between the first frictional surface 318a and the second frictional surface 318b. In this example, the first wall thickness 350 of the first frictional surface 318a is less than the second wall thickness 352 of the second frictional surface 318b.

The hysteresis and feedback generating device 338 includes a friction lever 340 having a main portion 340a pivotally mounted to the upper pedal arm 332 at a friction lever pivot point 342, and a lower portion 340c that angles inwardly and rearwardly from the upper pedal arm 332. The lower portion 340c includes an arcuate friction surface 340d. The arcuate friction surface 340d is complementary to the frictional surface of the friction wall 318.

The pedal assembly 310 further includes a spring 346 having one end attached to the end wall 315 of the housing 312 and the other end attached to the friction lever main portion 340a, as previously described with respect to FIG. 1. In this embodiment, the spring 346 is secured to the friction lever at a location that is beneath the friction lever pivot point 342 of the friction lever 340, so that the resultant force acting on the friction lever 340 directs the friction lever 340 downwardly against the frictional surface 318 of the friction wall 318.

In operation, rotation of the pedal arm 322 compresses the spring 316 while the friction lever 342 moves along the first frictional surface 318a of the friction wall 318, to create the frictional hysteresis force in the pedal assembly 310. When the friction lever encounters the step 318c, additional pedal effort is required to move the friction lever 340 past the step 318c, in order to replicate the kickdown force. The friction lever 340 travels along the second frictional surface 318c. However, slightly more effort is required by the operator to actuate the pedal assembly 310 than utilized through the first frictional surface 318a. It should be appreciated that in this example there may be two springs, an inner spring and an outer spring, as previously described.

It should also be appreciated that any of the above described pedal assemblies may include other components that are known in the art, such as an adjustable pedal height mechanism 484 or electrical connectors, or the like.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

1. An electronically controlled pedal assembly with hysteresis and kickdown comprising:
a housing having a mounting wall, a pair of opposed sidewalls, and an end wall, wherein the end wall includes a friction wall and the friction wall includes a first frictional surface having a first radius of curvature centered on a pedal arm pivot point and a second frictional surface having a second radius of curvature centered on the pedal arm pivot point, such that the second radius of curvature is less than the first radius of curvature, and a step transitions between the first frictional surface and the second frictional surface;
a pedal arm having an upper arm and a lower arm, and the pedal arm is rotatably supported at the pedal arm pivot point by a mounting means operatively connected to said housing;
a hysteresis and kickdown generating means pivotally attached to the upper pedal arm by a pivot pin; and
a spring positioned between the housing and the hysteresis and kickdown generating means, wherein the spring biases the hysteresis and kickdown generating means against the housing, such that rotation of the pedal arm by application of a first pedal load to the pedal arm compresses the spring to generate a first frictional hysteresis force between the hysteresis and kickdown generating means and the first frictional surface of the friction wall, rotation of the pedal arm by application of a second pedal load to the pedal arm generates a frictional kickdown force between the hysteresis and kickdown generating means and the step portion of the friction wall, and rotation of the pedal arm by application of a third pedal load to the pedal arm generates a second frictional hysteresis force between the hysteresis and kickdown generating means and the second frictional surface of the friction wall, and the first frictional hysteresis force, kickdown force and second frictional hysteresis force are translated back through said pedal arm.

2. The pedal assembly of claim 1 wherein the step is an angled wall extending between the first frictional surface and the second frictional surface.

3. The pedal assembly of claim 1 wherein the frictional wall is arcuate in shape.

4. The pedal assembly of claim 1 wherein the first frictional surface of the friction wall has a first wall thickness and the second frictional surface of the friction wall has a second wall thickness, and the first wall thickness is less than the second wall thickness.

5. The pedal assembly of claim 1 wherein the hysteresis and kickdown generating means is a friction lever pivotally connected to an outer end of the upper pedal arm by the pivot pin at a friction lever pivot point.

6. The pedal assembly of claim 5 wherein the friction lever includes an integrally formed main member and an upper arcuate member extending forwardly from an upper end of the main member, and an upper surface of the friction lever upper arcuate member is abraded to frictionally engage the friction wall.

7. The pedal assembly of claim 5 wherein said friction lever includes:
a friction lever pivotally connected to the upper pedal arm by a pivot pin at a friction lever pivot point;
a push arm pivotally mounted to the pedal arm at a push arm pivot point that is radially inward from the friction lever pivot point, wherein the push arm is in contact with the friction lever, such that the spring pushes the push arm against the friction lever.

8. The pedal assembly of claim 5 wherein the friction wall extends radially from the housing side wall between a rear wall of the housing and the pedal arm, and includes an arcuate frictional surface, and the friction lever includes a first portion pivotally mounted to the pedal arm and a second portion in frictional contact with the friction wall.

9. An electronically controlled pedal assembly with hysteresis and kickdown comprising:
a housing having a mounting wall, a pair of opposed sidewalls, and an end wail, wherein the end wall includes an arcuate friction wall and the friction wall includes a first frictional surface having a first radius of curvature centered on a pedal arm pivot point and a second frictional surface having a second radius of curvature centered on the pedal arm pivot point, such that the second radius of curvature is less than the first radius of curvature, and a step transitions between the first frictional surface and the second frictional surface;
a pedal arm having an upper arm and a lower arm, and the pedal arm is rotatably supported at the pedal arm pivot point by a mounting means operatively connected to said housing;
a hysteresis and kickdown generating means pivotally attached to said upper pedal arm that includes a friction lever pivotally attached to an outer end of the upper pedal arm by a pivot pin at a friction lever pivot point; and
a spring positioned between the housing and the hysteresis and kickdown generating means, wherein the spring biases the hysteresis and kickdown generating means against the housing, such that rotation of the pedal arm by application of a first pedal load to the pedal arm compresses the spring to generate a first frictional hysteresis force between the hysteresis and kickdown generating means and the first frictional surface of the friction wall, rotation of the pedal arm by application of a second pedal load to the pedal arm generates a frictional kickdown force between the hysteresis and kickdown generating means and the step portion of the friction wall, and rotation of the pedal arm by rotation of the pedal arm by application of a third pedal load to the pedal arm generates a second frictional hysteresis force between the hysteresis and kickdown generating means and the second frictional surface of the friction wall, and the first frictional force, kickdown force and second frictional force are translated back through said pedal arm.

10. The pedal assembly of claim 9 wherein the step is an angled wall extending between the first frictional surface and the second frictional surface.

11. The pedal assembly of claim 9 wherein the first frictional surface of the friction wall has a first wall thickness and the second frictional surface of the friction wall has a second wall thickness, and the first wall thickness is less than the second wall thickness.

12. The pedal assembly of claim 9 wherein the friction lever includes an integrally formed main member and an upper arcuate member extending forwardly from an upper end of the main member, and an upper surface of the friction lever upper arcuate member is abraded to frictionally engage the friction wall.

13. The pedal assembly of claim 9 wherein said friction lever includes:
a friction lever pivotally connected to the upper pedal arm by a pivot pin at a friction lever pivot point;
a push arm pivotally mounted to the pedal arm at a push arm pivot point that is radially inward from the friction lever pivot point, wherein the push arm is in contact with the friction lever, such that the spring pushes the push arm against the friction lever.

14. The pedal assembly of claim 9 wherein the friction wall extends radially from the housing side wall between a rear wall of the housing and the pedal arm, and includes an arcuate frictional surface, and the friction lever includes a first portion pivotally mounted to the pedal arm and a second portion in frictional contact with the friction wall.

15. An electronically controlled pedal assembly with hysteresis and kickdown comprising:
a housing having a mounting wall, a pair of opposed sidewalls, and an end wall, wherein the end wall includes an arcuate friction wall and the friction wall includes a first frictional surface having a first radius of curvature centered on a pedal arm pivot point and a first wall thickness, and a second frictional surface having a second radius of curvature centered on the pedal arm pivot point and a second wall thickness, such that the second radius of curvature is less than the first radius of curvature and the second frictional surface of the friction wall has a second wall thickness, and the first wall thickness is less than the second wall thickness, and a step transitions between the first frictional surface and the second frictional surface;
a pedal arm having an upper arm and a lower arm, and the pedal arm is rotatably supported at the pedal arm pivot point by a mounting means operatively connected to said housing;
a hysteresis and kickdown generating means pivotally attached to said upper pedal arm that includes a friction lever pivotally attached to an outer end of the upper pedal arm by a pivot pin at a friction lever pivot point; and
a spring positioned between the housing and the hysteresis and kickdown generating means, wherein the spring biases the hysteresis and kickdown generating means against the housing, such that rotation of the pedal arm by application of a first pedal load to the pedal arm compresses the spring to generate a first frictional hysteresis force between the hysteresis and kickdown generating means and the first frictional surface of the friction wall, rotation of the pedal arm by application of a second pedal load to the pedal arm generates a frictional kickdown force between the hysteresis and kickdown generating means and the step portion of the friction wall, and rotation of the pedal arm by application of a third load to the pedal arm generates a second frictional hysteresis force between the hysteresis and kickdown generating means and the second frictional surface of the friction wall, and the first frictional force, kickdown force and second frictional force are translated back through said pedal arm.

16. The pedal assembly of claim 15 wherein the step is an angled wall extending between the first frictional surface and the second frictional surface.

17. The pedal assembly of claim 15 wherein the friction lever includes an integrally formed main member and an upper arcuate member extending forwardly from an upper end of the main member, and an upper surface of the friction lever upper arcuate member is abraded to frictionally engage the friction wall.

18. The pedal assembly of claim 15 wherein said friction lever includes:
a friction lever pivotally connected to the upper pedal arm by a pivot pin at a friction lever pivot point;
a push arm pivotally mounted to the pedal arm at a push arm pivot point that is radially inward from the friction lever pivot point, wherein the push arm is in contact with the friction lever, such that the spring pushes the push arm against the friction lever.

19. The pedal assembly of claim 15 wherein the friction wall extends radially from the housing side wall between a rear wall of the housing and the pedal arm, and includes an arcuate frictional surface, and the friction lever includes a first portion pivotally mounted to the pedal arm and a second portion in frictional contact with the friction wall.
